(19) United States
(12) Patent Application Publication
(10) Pub. No.: US 2019/0359792 A1
(43) Pub. Date: Nov. 28, 2019

(54) FORMULATION OF MATERIAL FOR OPTIMIZING ADHERENCE WHEN INSULATING WIRES AND PRODUCT PRODUCED THEREFROM

(71) Applicant: CABOPOL - POLYMER COMPOUNDS, S.A., Porto De Mós (PT)

(72) Inventors: Rita Alexandra Ascenso MENESES SALVADA, Porto De Mós (PT); Joaquim Fernando MORAIS DA CRUS, Porto De Mós (PT); Tiago José GARRIDO DA COSTA, Porto De Mós (PT)

(21) Appl. No.: 16/484,560

(22) PCT Filed: Feb. 9, 2018
(86) PCT No.: PCT/IB2018/050810

§ 371 Date: Aug. 8, 2019

(30) Foreign Application Priority Data
Feb. 9, 2017 (PT) 109904

(51) Int. Cl. C08K 13/02; C08F 210/02; C08K 3/22; C08K 5/5425; C08K 5/20; C08K 5/134; C08J 3/24

(52) U.S. Cl. CPC C08K 13/02; C08F 210/02; C08K 3/22; C08K 5/5425; C08K 2003/2227; C08K 5/1345; C08J 3/24; C08F 2810/20; C08K 5/20

(57) ABSTRACT

This invention falls within the scope of insulation materials, more particularly of compounds intended for optimizing the adhesion on the insulation of wires used in cars. It is the object of this invention a formulation which comprises, in percentage by weight of the components relative to the total weight of the composition, 10% to 40% of a polyolefin, 40% to 60% of a mineral filler, 1% to 4% of an antioxidant, 1 to 2% of an organosilane, 0.5 to 2.5% of an organic peroxide and 0.1 to 0.5% of erucamide. Additionally, it is also an object of this invention a product obtained by mixing the said formulation and subsequent crosslinking of the same. This formulation allows a compound to be obtained, which complies with the required standards, as well as controls and improves the adhesiveness of the insulating material to the conducting wire, this representing an important aspect on the wiring process.

### FIELD OF THE INVENTION

This invention falls within the scope of automotive construction, more specifically, the manufacture of electrical components, and even more specifically an insulating material suitable for application in wirings. The invention discloses an insulating material which is resistant temperatures in the range of from −40° C. to +125° C., complying with the standards ISO 6722-1, GMW15626 and SAE J 1128, and which has an optimal and time-stable adhesion to the conducting wire.

### BACKGROUND OF THE INVENTION

There are patent applications related to similar formulations intended for this use with a polymeric base and flame retardants, such as the patent applications US20080188604 or US20070149680. However, no reference is made in what concerns:
Additives with properties which allow to control and improve the adhesion of the insulating material to the conducting wire, this being an important aspect in the wiring process.
A process for addition of the crosslinking agent under controlled conditions of temperature.

This invention presents a significant improvement comparatively to the already existing formulations, an increased adhesion of the insulating material to the conducting wire, as well as a process for obtaining the same with relevant advantages such as the control of temperature.

### SUMMARY OF THE INVENTION

This invention discloses a formulation and a process for obtaining the said formulation, which complies with the required standards and allows for the control and improvement of the adhesion of the insulating material to the conducting wire, which is an important aspect in the wiring process.

The invention discloses a process for addition (infusion) of the crosslinking agent under controlled conditions of temperature.

The chemical peroxide crosslinking process under controlled conditions of extrusion does not always allows the adhesion to the conducting wire to be kept within the specified values which are acceptable for the end-user, in this case the cablers.

In a formulation obtained by the chemical peroxide crosslinking process, keeping the adhesiveness within the established parameters for application in wirings is a requirement that must be met, and it represents the basis of this development.

The currently used method for direct injection of the crosslinking agent into the extruder requires a strictly controlled process to be followed, which is sensitive to temperature peaks. The infusion system disclosed in this invention is now able to solve that problem, since it allows for a good dispersion of the crosslinking agent while simultaneously controlling an eventual early reactivity.

Therefore, new compositions are required for the insulation of wires used in the automotive industry, which allow for a stable adhesion from the wire extrusion to its application in wirings. The said compositions are disclosed in this invention.

### DETAILED DESCRIPTION OF THE INVENTION

The formulation of this invention consists of a polymeric matrix containing one or more of polyolefin and functional additives. The additives will preferably be an erucamide, aluminium hydroxide or magnesium hydroxide, since they have flame retardant properties, a crosslinking agent, namely peroxide, and also an organosilane, which acts as a coupling agent to the filler. This formulation shows an improved and time-stable behaviour of adhesion to the conducting wire.

The formulation disclosed is the object of this invention.

In a preferred embodiment, the percentage by w/w of polyolefin in the formulation will be from 10 to 40%, the said polyolefin containing from 12 to 33% of vinyl acetate. In an advantageous embodiment, the polyolefin will be ethylene vinyl acetate (EVA).

Preferably, the additives of the formulation of this invention with polymeric matrix are:
an erucamide;
an antioxidant;
an organosilane;
an agent with flame retardant properties;
and a crosslinking agent.

In a preferred embodiment, erucamide is found in the formulation in an amount of from 0.1 to 0.5% (w/w) and it can be selected among the following organic erucamides: (Z)—N-octadecyldocos-13-enamide or Z)-Docos-13-enamide; (Z)-13-Docosenamide; (13Z)-13-Docosenamide; (Z)-Docos-13-enamide Erucic acid amide 13-Docosenoic acid amide cis-13-Docosenoamide or Erucylamide; 13-Docosenamide.

Preferably, the antioxidant is Pentaerythritol tetrakis(3-(3,5-di-tert-butyl-4-hydroxyphenyl)propionate), known as irganox 1010, and it is present in the formulation in an amount of from 1 to 4% (w/w).

In a preferred embodiment, the formulation comprises organosilane in an amount of from 1 to 2% (w/w), and the organosilane is vinyltrimethoxysilane.

In an advantageous embodiment, the mineral filler with flame retardant properties is aluminium hydroxide or magnesium hydroxide, and it is present in the formulation in an amount of from 40 to 60% (w/w).

Preferably, the crosslinking agent is present in an amount of from 0.5 to 2.5% (w/w).

Preferably, the crosslinking agent is a peroxide selected among the following: t-butyl cumyl peroxide, benzoyl peroxide, cumene hydroperoxide, dicumyl peroxide, methyl ethyl ketone peroxide, 2,5-dimethyl-2,5-di(tert-butylperoxy)hexane, di-tert-butyl peroxide, t-butyl peroxybenzoate.

In an even more advantageous embodiment, the peroxide is 2,5-dimethyl-2,5-di(tert-butylperoxy)hexane.

During the wire extrusion, the erucamide migrates into the insulating material/copper interface, thus allowing for an optimal adhesiveness. The migration rate will depend on the molecular weight of the chosen erucamide.

Table 1 shows the results obtained with the use of this formulation, which provide evidence of its efficacy when analysing the adhesion parameter.

TABLE 1

| | | After 3 | After 10 | After 18 |
|---|---|---|---|---|
| | Day 0 | days | days | days |
| | Adhesion | Adhesion | Adhesion | Adhesion |
| Sample | (N) | (N) | (N) | (N) |
| 0% Erucamide | 93 | 98 | 80.5 | 80 |
| 0.2% Erucamide | 20 | 21 | 21 | 20 |

As can be concluded from the data in Table 1, the absence of erucamide results in a high adhesion, which does not comply with the applicable standards, i.e., <50N.

When adding 0.2% w/w of erucamide to the formulation, it is verified that it acts as a secondary lubricant, thus reducing the adhesiveness to values of 20N, which are considered rather acceptable for the normal conditions of application in the wiring process.

Another object of the invention will be the process for infusion of the peroxide into the formulation of this invention. The process comprises the following steps:
a) Homogenizing the polyolefin with aluminium hydroxide, an antioxidant, an organosilane and the selected erucamide in a kneader-type extruder, also being possible to use double-spindle technology or an internal mixer (Banbury);
b) Pelletizing the formulation of the step a), which occurs by underwater cutting, followed by cooling;
c) Gravimetric dosing of the formulation of the previous steps;
d) Injection, in a rotary reactor with stirring from 100 to 300 rpm, into the formulation obtained from the previous steps and at a temperature in the range of from +40 to +60° C., of the liquid crosslinking agent, peroxide, using a pump provided with flow meter and control.

In a preferred embodiment, 1.5% of liquid crosslinking agent at 98.5% is injected into the formulation of the steps a) to c).

This invention will be better understood with reference to the following examples. However, the examples are not intended to limit the scope of the invention.

### EXAMPLES—TRIALS #1 TO #4

Table 2 shows formulations according to this invention, which were crosslinked with 2,5-dimethyl-2,5-di(tert-butylperoxy)hexane peroxide, resulting in compounds obtained by mixing the components of the formulation and subsequent extrusion, after which the moulded plates were produced, the said plates being then crosslinked by means of crosslinking with peroxide.

TABLE 2

| Components % | | | | |
|---|---|---|---|---|
| (w/w) | # 1 | # 2 | # 3 | # 4 |
| EVA (18% Vinyl | 39 | 38.8 | 38.7 | 38.6 |
| Acetate) | | | | |
| Aluminium | 55 | 55 | 55 | 55 |
| hydroxide | | | | |
| Antioxidant | 3 | 3 | 3 | 3 |
| Organosilane | 1.5 | 1.5 | 1.5 | 1.5 |
| Peroxide | 1.5 | 1.5 | 1.5 | 1.5 |
| Erucamide | 0 | 0.2 | 0.3 | 0.4 |

In the trials shown in table 2, a double-spindle extruder was used. The polyolefin used was EVA. The initially added amount of aluminium hydroxide was 25% (w/w). These components were put into a mixer in the first supply. In a lateral feeder, the remaining portion of 30% (w/w) of aluminium hydroxide was added.

A Brabender rheometer was used for testing the processability and the addition of peroxide at 1.5% w/w, which remained constant in all the trials #1#2#3#4.

The formulae were produced and the crosslinked plates were tested according to the Standard ISO6722, with the following results being obtained:

| | Trials | | | |
|---|---|---|---|---|
| | # 1 | # 2 | # 3 | # 4 |
| Density g/cm3 | 1.47 | 1.47 | 1.46 | 1.47 |
| Breaking Load | 13 | 15.1 | 16.1 | 15.9 |
| MPa | | | | |
| Elongation % | 235 | 210 | 195 | 188 |
| Flame 45° | Complies | Complies | Complies | Complies |
| Winding −40° C. 4 h | Complies | Complies | Complies | Complies |
| Aging | Complies | Complies | Complies | Complies |
| +150° C. 240 h | | | | |
| Aging | Complies | Complies | Complies | Complies |
| +125° C. 3000 h | | | | |
| Adhesion N | 50-80 | 25-30 | 20-22 | 12-18 |

From the aforementioned examples, it is concluded that trial #1 does not contain erucamide, thus originating high values of adhesion 50-80N, which makes difficult to separate the insulating material from the copper.

In trials #2 #3 #4 the use of erucamide causes the adhesion values to decrease to 25-20N, 20-22N and 12-18N, respectively. The desirable adhesion is, preferably, within the range of 20-25N.

It can also be concluded that the presence of erucamide does not affect the remaining critical properties of aging at +150° C. for 240 hours and at +125° C. for 3000 hours, as well as the mechanical properties.

These results support that which was previously explained, i.e. the erucamide acts as a secondary lubricant, which a few moments after the extrusion exudes into the interface with the conducting wire, thus allowing for a good stability being obtained in the adhesion to the conducting wire.

As will appear evident to a person skilled in the art, several changes in details can be made, which shall remain within the scope of this invention.

This invention shall be limited only by the spirit of the following claims.

1. A formulation characterized in that it comprises in percentage by weight of the components relative to the total weight of the composition:
a) 10% to 40% of a polyolefin;
b) 40% to 60% of mineral filler;
c) 1% to 4% of an antioxidant;
d) 1 to 2% of an organosilane;
e) 0.5 to 2.5% of an organic peroxide; and
f) 0.1 to 0.5% of erucamide.

2. A formulation according to claim 1, characterized in that the polyolefin is ethylene comprising 12 to 33% of ethylene vinyl acetate (EVA).

3. A formulation according to claim 1, characterized in that the erucamide is selected among the following compounds: (Z)—N-octadecyldocos-13-enamide or Z)-Docos-13-enamide; (Z)-13-Docosenamide; (13Z)-13-Docosenamide; (Z)-Docos-13-enamide Erucic acid amide 13-Docosenoic acid amide cis-13-Docosenoamide or Erucylamide; 13-Docosenamide.

4. A formulation according to claim 1, characterized in that the organosilane is vinyltrimethoxysilane.

5. A formulation according to claim 1, characterized in that the antioxidant is Pentaerythritol tetrakis(3-(3,5-di-tert-butyl-4-hydroxyphenyl)propionate).

6. A formulation according to claim 1, characterized in that the mineral filler is aluminium hydroxide.

7. A formulation according to claim 1, characterized in that the crosslinking agent is selected among the following compounds: t-butyl cumyl peroxide, benzoyl peroxide, cumene hydroperoxide, dicumyl peroxide, methyl ethyl ketone peroxide, 2,5-dimethyl-2,5-di(tert-butyl-peroxy)hexane, di-tert-butyl peroxide, t-butyl peroxybenzoate.

8. A formulation according to claim 5, characterized in that the peroxide is 2,5-dimethyl-2,5-di(tert-butylperoxy)hexane.

9. A product characterized in that it is obtained from the process of:
a) Homogenizing the components of the formulation according to any of the previous claims;
b) Pelletizing the formulation of the step a);
c) Gravimetric dosing of the formulation of the previous steps;
d) Crosslinking of the formulation of the previous steps by means of injection of a liquid crosslinking agent.

10. A product according to claim 9, characterized in that the liquid crosslinking agent is a peroxide.

11. A product according to claim 10, characterized in that the peroxide is 2,5-dimethyl-2,5-di(tert-butyl-peroxy)hexane.

12. A product according to claim 9, characterized in that the pelletizing process mentioned in step b) occurs by underwater cutting, followed by cooling.

13. A product according to claim 9, characterized in that the injection of the liquid crosslinking agent from the step d) is carried out in a rotary reactor, with stirring from 100 to 300 rpm and at a temperature between +40 and +60° C.
